(19) United States
(12) Patent Application Publication
(10) Pub. No.: US 2015/0216339 A1
(43) Pub. Date: Aug. 6, 2015

(54) Jewelry Pendant Assembly

(71) Applicant: Jessica McFarland, Cunningham, KS (US)

(72) Inventor: Jessica McFarland, Cunningham, KS (US)

(21) Appl. No.: 14/689,819

(22) Filed: Apr. 17, 2015

(51) Int. Cl. A47G 19/22; F21V 33/00; F21L 4/00; B65D 23/08

(52) U.S. Cl. CPC A47G 19/2227; B65D 23/0892; F21V 33/0004; F21L 4/00; A47G 2200/08; F21Y 2101/02

(57) ABSTRACT

A jewelry pendant assembly incorporating a vessel having an interior space and having a wall, the wall having an annular outer surface, the wall being composed of a translucent material; a bead strand fixedly attached to and wrapped in a plurality of turns about the vessel's annular outer surface, the plurality of bead strand turns forming diamond pattern beadwork; a battery powered illuminator configured as an electric torch fitted for receipt within the vessel's interior space, the electric torch's body extending into the vessel and positioning a light emitting diode for, upon actuation of the battery powered illuminator, projecting light through the vessel's wall and about the bead strand turns.

### FIELD OF THE INVENTION

This invention relates to jewelry pendants of the type adapted for personal ornamentation in the manner of necklaces, earrings, brooches, bracelets, and finger rings. More particularly, this invention relates to such pendants which are adapted for battery powered illumination.

### BACKGROUND OF THE INVENTION

Illuminated jewelry items such as battery powered LED illuminated brooches, battery powered LED illuminated necklace pendants, and battery powered illuminated earring pendants are known. Such illuminated jewelry items commonly lack decorative interest and appeal, and commonly project an uninteresting light display, such defects and deficiencies undermining the personal decorating or ornamenting performance capabilities of such jewelry.

The instant invention jewelry pendant assembly solves or ameliorates the drawbacks and deficiencies described above by providing a translucent vessel and battery powered light emitting diode combination wherein the vessel is wrapped or encased within a specialized matrix of bead strand turns.

### BRIEF SUMMARY OF THE INVENTION

A first structural component of the instant inventive jewelry pendant assembly comprises a vessel having an outer wall which forms and defines an interior space. In a preferred embodiment the vessel comprises a substantially cylindrical jar or bottle, and is composed of translucent or transparent glass or plastic. In a preferred embodiment, the vessel wall is colorless. Suitably, and for the sake of decorative appearances, the vessel wall may alternatively be colored.

A further structural component of the instant inventive jewelry pendant assembly comprises a bead strand which is fixedly attached to the vessel and which is wrapped thereabout in a plurality of turns. In a preferred embodiment, the plurality of bead strand turns forms a diamond pattern mesh, network or matrix which substantially completely encases the outer surfaces of the vessel.

A further structural component of the instant inventive jewelry pendant assembly comprises a battery powered illuminator which is fitted for insertion into and receipt within the vessel's interior space. In a preferred embodiment, the battery powered illuminator comprises an electric torch or flashlight housing which encases a series of wafer batteries and a light emitting diode. Suitably, the battery powered illuminator may alternatively comprise a conventional incandescent or florescent light bulb.

A further structural component of the instant inventive jewelry pendant assembly comprises mounting means position the battery powered illuminator for, upon electrical actuation, projecting light outwardly and through the vessel's wall, and through and about the matrix configured bead strand. Such light projection advantageously creates an appealing appearance, enhancing the decorative function of the jewelry item.

Accordingly, objects of the instant invention include the provision of a jewelry pendant assembly which incorporates structures as described above, and which arranges those structures in manners described above for performance of the beneficial and advantageously functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a side view of a preferred embodiment of the instant inventive jewelry pendant assembly, the view including a “cutaway” section for exposure of underlying structures.

FIG. 2 is a partially exploded view of the structure depicted in FIG. 1.

FIG. 3 is an upper plan view of the structure depicted in FIG. 2, the view showing fabrication process steps.

FIG. 4 is a magnified partial view of the structure of FIG. 3, as indicated in FIG. 3.

### DETAILED DESCRIPTION OF A PREFERRED EMBODIMENT

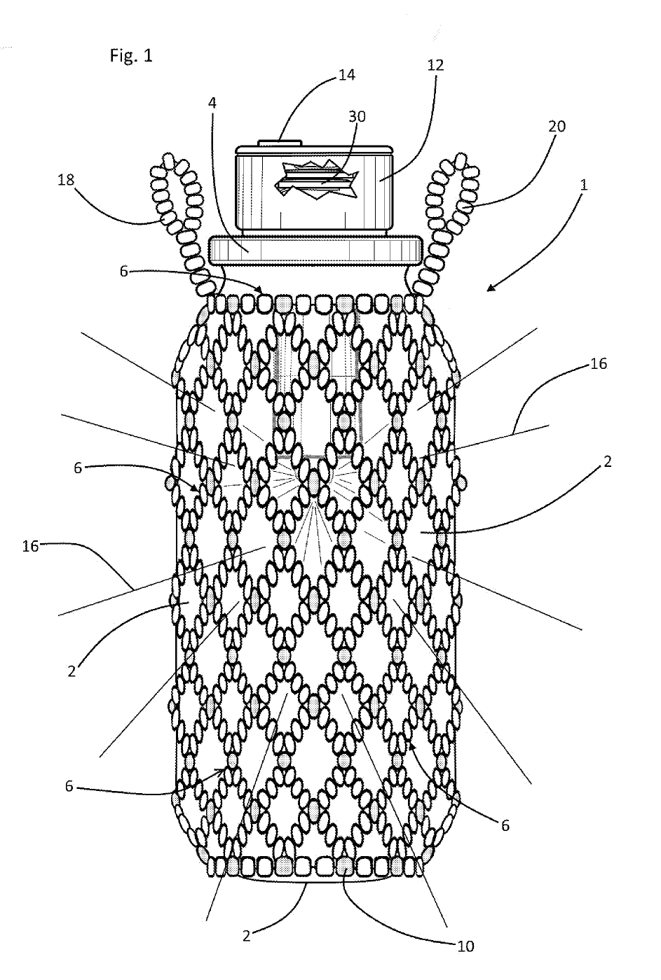

Referring now to the drawings and in particular to Drawing FIG. 1, a preferred embodiment of the instant inventive jewelry pendant assembly is referred to generally by Reference Arrow 1. In a preferred embodiment, the jewelry pendant 1 constitutes a necklace pendant, preferably approximately 1¼ inches in height, and approximately 1 inch in diameter. Such pendant 1 is intended as being representative of other types of jewelry pendants which may be worn as a brooch, as earrings, as a finger ring, or as a bracelet pendant.

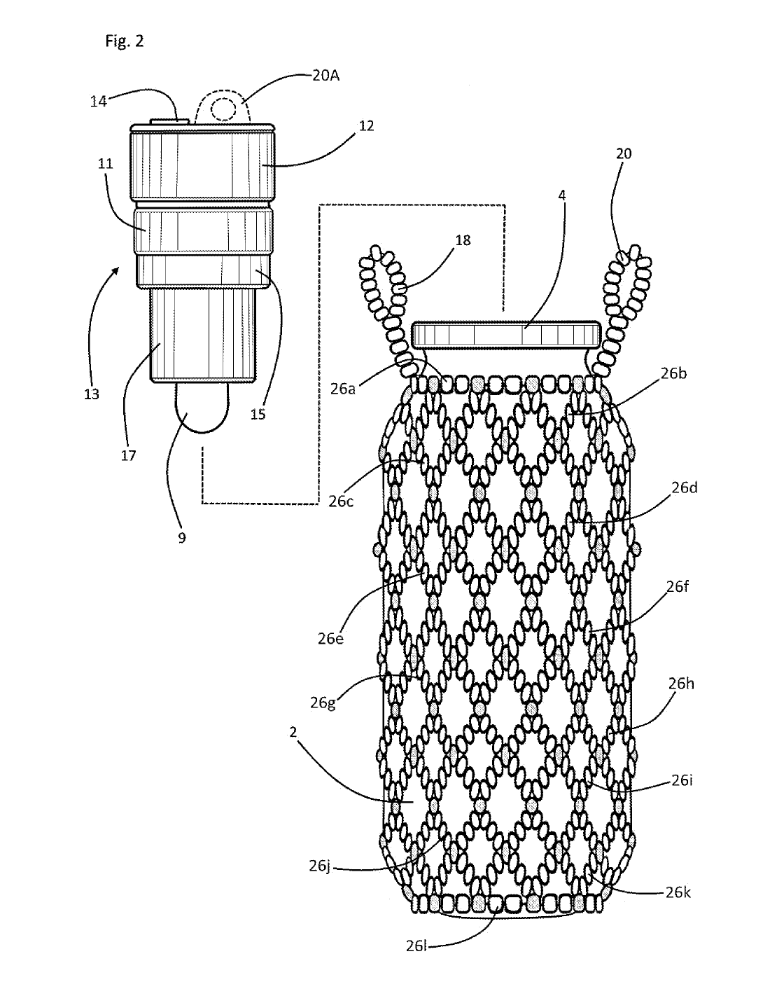

Referring simultaneously to FIGS. 1 and 2, the vessel component preferably comprises a bottle or jar 2 which has a transparent or translucent wall, and has a cylindrically bored upper opening 4. In a preferred embodiment, the vessel 2 is composed of clear or transparent glass. Suitably, the vessel 2 may be composed of transparent plastic. Also suitably, the vessel 2 may comprise colored glass or plastic.

Referring to FIG. 1, a further structural component of the inventive jewelry pendant assembly comprises a bead strand which is referred to generally by Reference Arrows 6. In a preferred embodiment, the bead strand 6 extends about the outer peripheral surface of the wall of the vessel 2 in a plurality of turns. Such bead strand turns preferably comprise beadwork which forms the depicted diamond pattern mesh or netting matrix which encircles or encases the vessel 2. Fabrication steps directed to such matrix of bead strand turns 6 are further described below.

A further structural component of the instant inventive jewelry pendant assembly comprises a battery powered illuminator which is referred to generally by Reference Arrow 13. In a preferred embodiment, the battery powered illuminator is configured as a small electric torch or flashlight and comprises an upper hollow battery housing 12. As is shown in FIG. 1 via exemplary cutaway section, wafer batteries 30 are preferably housed within battery housing 12, such batteries 30 being supported by electrical contacts which are components of an electric circuit including an upwardly exposed on/off switch 14.

A cylindrical body 15 is preferably fixedly attached to and extends downwardly from the battery housing 12, and an LED positioning section 17 preferably extends downwardly from the cylindrical body 15. A light emitting diode 9 is preferably supported at the lower end of the positioning section 17, the light emitting diode 9 constituting an additional component of the electric circuit which includes the batteries 30 and the on/off switch 14.

The electric torch illuminator 13 comprises mounting means which are adapted for downwardly positioning the light emitting diode 9 within the interior of the vessel 2 as indicated in FIG. 1. To further facilitate and secure such LED positioning, an elastomeric friction sleeve 11 is preferably disposed about the annular outer periphery of the cylindrical body 15, such sleeve 11 compressively filling the annulus between the cylindrical inner bore of the bottle neck 4 and the electric torch's cylindrical body 15, such sleeve 11 securely holding the electric torch illuminator 13 at the position indicated in FIG. 1.

The electric torch illuminator 13 depicted in FIGS. 1 and 2 is intended as being representative of other commonly known mounting means which are capable of positioning a battery powered illuminator (such as the light emitting diode 9) within the interior of vessel 2. The light emitting diode 9 is intended as being representative of other battery powered illuminators such as incandescent bulbs and florescent bulbs.

Upon assembly of vessel and electric torch components as indicated in FIG. 1, and upon depression of on/off switch 14 to actuate the LED illuminator 9, light rays 16 emit from the illuminator 9 and pass through the translucent wall of the vessel 2 to extend through and about the bead strand turns 6. Such emission of light 16 through and about the bead strand turns 6 advantageously imparts a specialized, appealing, and decorative appearance to the pendant 1, such light projection enhancing the pendant's function as a jewelry item.

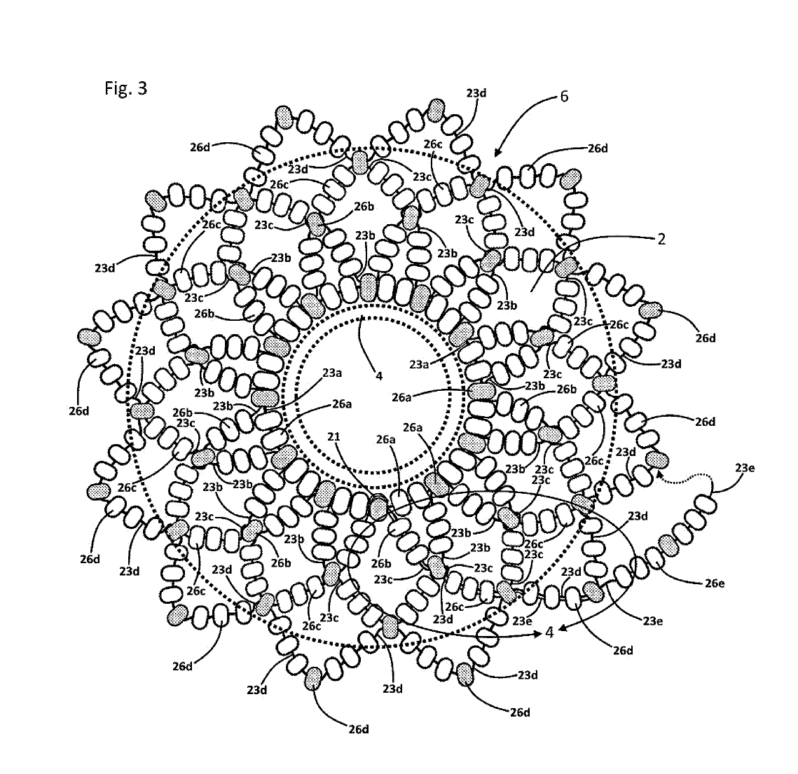

Referring simultaneously to FIGS. 1-4, a fabricator of the instant inventive jewelry pendant assembly may initially extend a first or uppermost turn of the bead strand turns 6 about the neck 4 of the vessel 2 in the repeating pattern indicated in FIG. 3. Such first bead strand turn preferably includes a first or uppermost thread turn 23a having a first or uppermost series of beads 26a threaded therealong. In a preferred embodiment, the base or beginning end of the first thread turn 23a includes an anchoring tie 21 secured at a beginning or first bead among beads 26a. From such tied beginning bead, the bead strand's initial turn extends about the bottle neck 4 in a regular and orderly series of beads wherein anchor or linking beads designated via shading are regularly arrayed. In the exemplary first turn of the bead strand 23a,26a, shaded beads are purposefully strung, such beads being regularly spaced by pairs of differently colored non-linking beads. Depending upon the selected bead size and the diameter of the bottle neck, various and different numbers of linking beads and non-linking spacing beads may be provided.

Referring simultaneously to FIGS. 2-3, upon completion of the first turn of the thread 23a, such thread is preferably re-extended through the tied bead 21, and is further extended therefrom as a commencement of a successive thread turn 23b. Such successive thread turn 23b preferably extends in a looping fashion through each of the shaded linking beads among beads 26a. Ordered series of beads are preferably threaded upon each loop of the thread turn 23b between each of the shaded 26a linking beads. In the example of FIG. 3, each looped bead series among beads 26b comprises seven beads, each such series consisting of shaded linking bead which is centrally positioned between a pair of triples of preferably differently colored non-linking beads. Depending upon selected bead sizes and bottle dimensions, the numbers of beads provided in such bead strand loop series may vary.

Upon completion of the extensions of the thread turn 23b through each of the linking beads among beads 26a, such thread turn 23b is redesignated as a next successive thread turn 23c. Upon its commencement, thread turn 23c is extended (preferably through use of a needle) through the first four beads of the first bead loop among beads 26b. Thereafter, the redesignated thread turn 23c further extends in a looping fashion through the shaded linking beads among beads 26b in a manner identical to the next preceding bead strand turn 23b,26b. In fabrication of the next successive bead strand turn, thread turn 23d is similarly extended through the shaded linking beads among beads 26c, and identical bead series 26d are threaded in the looping fashion between such linking beads.

As is particularly shown in FIG. 3, thread turn 23e enters and emerges from a final shaded linking bead among beads 23d, and is rethreaded through the first four beads of the first loop series of such beads 23d. Thereafter, beads 26e are threaded onto thread turn 23e, while thread turn 23e successively links with the shaded linking beads among beads 26d in the manner indicated by the dotted line arrow drawn upon FIG. 3.

As is shown in Drawing FIG. 2, the above described beadworking steps preferably continue until bead strand turns consisting of bead and thread turns 26f, 26g, 26h, 26i, 26j, 26k, and 261 are completed. The final or lowermost bead strand turn 261 is preferably tied off and is anchored at the lower end of the vessel 2. Upon completion of such bead work, a diamond pattern or matrix of bead strand turns 6 is advantageously formed, such matrix having an appealing appearance.

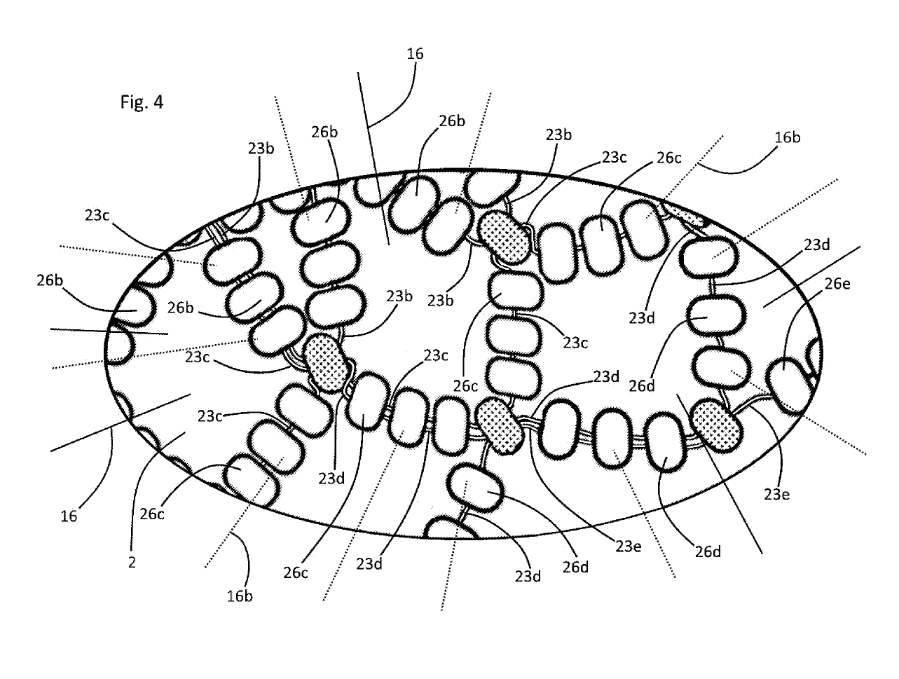

Referring in particular to FIG. 4, in a preferred embodiment, a plurality of the beads are, similarly with the translucent character of the wall of the vessel 2, translucent allowing light rays 16b to pass through such beads in addition to the passage of light rays 16.

In a preferred embodiment, referring simultaneously to FIGS. 1 and 2, a pair of beaded suspension loops 18 and 20 are preferably fixedly attached to an uppermost turn among the bead strand turns 6, such suspension loops 18 and 20 being utilizable for necklace, chain, or bracelet suspension. Suitably, a fixed loop or eye 20A integrally molded with and extending upwardly from the battery housing 12 may be alternatively or additionally provided for such jewelry suspension.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope at least commensurate with the appended claims.

The invention hereby claimed is:

1. A jewelry pendant assembly comprising:
(a) a vessel having an interior space and having a wall, the wall having an annular outer surface, the wall being composed of a translucent material;
(b) a bead strand fixedly attached to and wrapped in a plurality of turns about the wall's annular outer surface;
(c) a battery powered illuminator, the battery powered illuminator being fitted for receipt within the interior space; and
(d) means for mounting the battery powered illuminator, said means positioning the battery powered illuminator for, upon actuation of the battery powered illuminator, projecting light through the vessel's wall and about the bead strand's turns.

2. The jewelry pendant assembly of claim 1 wherein each of the bead strand's turns about the wall's annular outer surface comprises a plurality of beads, each such bead plurality comprising a plurality of linking beads.

3. The jewelry pendant assembly of claim 2 wherein each linking bead joins an adjacent pair of bead strand turns, the joined adjacent pairs of bead strand turns forming a diamond beadwork pattern about the vessel's wall.

4. The jewelry pendant assembly of claim 3 wherein the vessel comprises a bottle having an upper opening.

5. The jewelry pendant assembly of claim 4 wherein each bead among the plurality of linking beads has a color, wherein each of the bead strand's other beads has a color, the linking beads' color differing from said other beads' color.

6. The jewelry pendant assembly of claim 4 wherein the battery powered illuminator comprises a light emitting diode.

7. The jewelry pendant assembly of claim 6 wherein the bottle's upper opening forms a cylindrical bore, wherein the means for mounting the battery powered illuminator comprises an electric torch housing having a cylindrical body having a lower end, wherein the battery powered illuminator's light emitting diode is supported at said lower end.

8. The jewelry pendant assembly of claim 7 wherein a plurality of beads among the bead strand's beads are translucent.

9. The jewelry pendant assembly of claim 8 further comprising a friction sleeve annularly disposed between the electric torch's cylindrical body and the bottle's cylindrical bore, the means for mounting the battery powered illuminator comprising said friction sleeve.

10. The jewelry pendant assembly of claim 9 further comprising a pair of bead strand attachment loops fixedly attached to an uppermost turn among the bead strand's plurality of turns.
